(19) United States
(12) Patent Application Publication
(10) Pub. No.: US 2025/0304387 A1
(43) Pub. Date: Oct. 2, 2025

(54) MEDIUM CONVEYANCE APPARATUS AND RECORDING APPARATUS

(71) Applicant: SEIKO EPSON CORPORATION, Tokyo (JP)

(72) Inventors: Haruki MIYASAKA, MATSUMOTO-SHI (JP); Nobuyuki NISHI, HARA-MURA (JP); Masashi OGAWA, SHIOJIRI-SHI (JP)

(21) Appl. No.: 19/087,713

(22) Filed: Mar. 24, 2025

(30) Foreign Application Priority Data
Mar. 27, 2024 (JP) 2024-051314

(51) Int. Cl. B65H 5/06; B41J 13/03; B41J 13/10; B41J 29/13; B65H 1/04; B65H 3/06

(52) U.S. Cl. CPC B65H 5/06; B41J 13/03; B41J 13/103; B41J 29/13; B65H 1/04; B65H 3/06; B65H 2301/34; B65H 2301/42324; B65H 2301/443; B65H 2801/12; B65H 2801/15

(57) ABSTRACT

A medium conveyance apparatus includes an apparatus body and a reverse path unit. The reverse path unit includes a reverse roller configured to reverse a medium, and the reverse path unit is configured to be attachable/detachable to/from the apparatus body. The reverse path unit includes a support tray, an operation unit, and an opening portion. The support tray is configured to switch between a drawn state where the support tray is drawn out from the reverse path unit and a stored state where the support tray is stored in the reverse path unit. The support tray is configured to support a medium to be fed in the drawn state. The operation unit is operated to attach/detach the reverse path unit to/from the apparatus body. The opening portion is provided in the support tray and configured to enable operation of the operation unit.

The present application is based on, and claims priority from JP Application Serial Number 2024-051314, filed Mar. 27, 2024, the disclosure of which is hereby incorporated by reference herein in its entirety.

### BACKGROUND

### 1. Technical Field

The present disclosure relates to a medium conveyance apparatus and a recording apparatus.

### 2. Related Art

For example, JP-A-2018-134854 discloses a recording apparatus including a medium conveyance apparatus including a reverse path unit (medium reverse unit).

The recording apparatus includes a support tray (auxiliary tray) configured to support a medium such as paper set in a back surface feeding unit. The reverse path unit is a mechanism configured to reverse the medium supplied from the support tray after the medium is reversely conveyed after recording, and therefore the reverse path unit is mounted on the same side as the support tray with respect to the apparatus body of the recording apparatus. The reverse unit is removed from the apparatus body when a clogged medium is removed from a conveyance path at the time of an occurrence of a jam such as a paper jam. Therefore, the back surface of the reverse path unit mounted to the apparatus body is provided with an operation unit such as an unlocking lever configured to release the lock for the user to remove the reverse path unit from the apparatus body.

The operation unit is provided at a position avoiding a support plate in a width direction of the medium. A pair of operation units are provided so that an unlock operation of pressing the operation units toward the center direction in the width direction of the apparatus body can be performed. The pair of operation units are provided at positions on both sides of the support tray in the width direction of the apparatus body.

However, in the recording apparatus described in JP-A-2018-134854, since the pair of operation units are provided at positions avoiding the support tray in the width direction, the positions in the width direction of the pair of operation units are limited to the width size of the support tray. For example, when the width size of the support plate is increased, the interval between the pair of operation units is increased. In this case, it is difficult for the user to perform an operation with one hand. On the other hand, when the width size of the support tray is too small compared to the width size of the medium, both end portions in the width direction of the medium sag from the support tray. Supply of the medium to the apparatus body in this state causes recording failures or malfunctions such as an occurrence of a jam or rubbing of the medium against the recording head. Therefore, there is a demand for a medium conveyance apparatus configured to dispose the operation unit at a desired position without being limited to the width size of the support tray in the width direction of the apparatus body.

### SUMMARY

A medium conveyance apparatus configured to solve the above problem includes an apparatus body, and a reverse path unit including a reverse roller configured to reverse a medium, the reverse path unit being configured to be attachable/detachable to/from the apparatus body, in which the reverse path unit includes a support tray configured to switch between a drawn state where the support tray is drawn out from the reverse path unit and a stored state where the support tray is stored in the reverse path unit, and configured to support a medium to be fed in the drawn state, an operation unit operated to attach/detach the reverse path unit to/from the apparatus body, and an opening portion provided in the support tray and configured to enable operation of the operation unit.

A recording apparatus configured to solve the above problem includes the medium conveyance apparatus and a recording unit configured to perform recording on the medium conveyed by the medium conveyance apparatus.

### BRIEF DESCRIPTION OF THE DRAWINGS

FIG. 1 is a perspective view illustrating a recording apparatus in an embodiment.

FIG. 2 is a perspective view illustrating the recording apparatus with a front cover in an open position.

FIG. 3 is a perspective view illustrating the recording apparatus when performing recording.

FIG. 4 is a schematic side cross-sectional view illustrating the recording apparatus.

FIG. 5 is a perspective view illustrating a reverse path unit in a mounted state.

FIG. 6 is a front view illustrating the reverse path unit in a mounted state.

FIG. 7 is a perspective view illustrating the recording apparatus in a state where the reverse path unit is drawn out.

FIG. 8 is a perspective view illustrating the reverse path unit.

FIG. 9 is a plan view illustrating the reverse path unit.

FIG. 10 is a side cross-sectional view illustrating the reverse path unit.

FIG. 11 is a side cross-sectional view illustrating a reverse path unit of a modification.

FIG. 12 is a perspective view of a support tray in a modification different from that of FIG. 11 as viewed from the inside.

### DESCRIPTION OF EMBODIMENTS

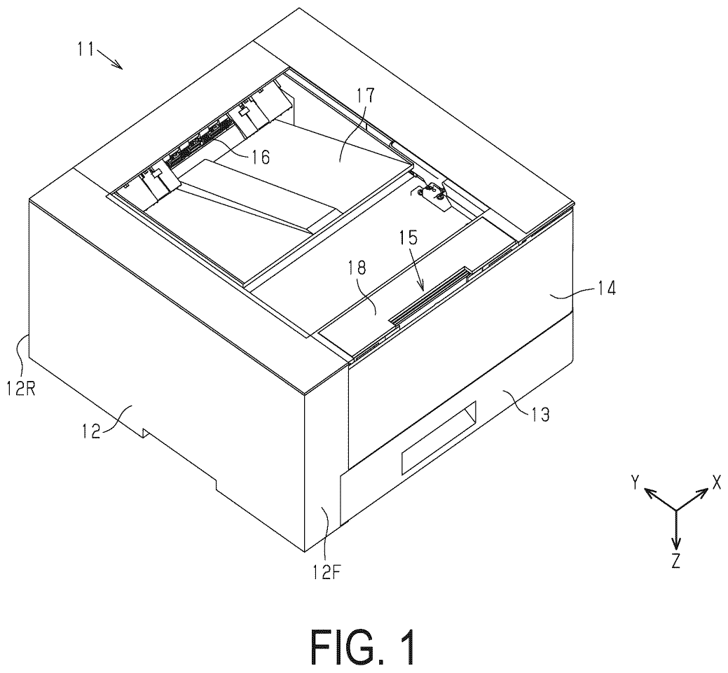

Hereinafter, an embodiment of a medium conveyance apparatus and a recording apparatus including the medium conveyance apparatus will be described with reference to FIGS. 1 to 10. First, an overall configuration of the recording apparatus will be described with reference to FIGS. 1 to 3.

In FIGS. 1 to 3, on an assumption that a recording apparatus 11 is placed on a horizontal plane, three directions orthogonal to one another are defined as an X direction, a Y direction, and a Z direction, respectively. The Z direction parallel to the gravity direction is defined as a vertical direction Z. The X direction and the Y direction are two directions orthogonal to each other along the horizontal plane. The X direction is a width direction of the recording apparatus 11, and therefore it is also called a width direction X. The Y direction is a depth direction of the recording apparatus 11, and therefore it is called a depth direction Y. In the recording apparatus 11 of the present embodiment, the conveyance direction in which a medium is conveyed at a recording position where the recording apparatus 11 records on the medium is parallel to the Y direction. Therefore, the Y direction is also called a conveyance direction Y. One end side in the conveyance direction Y of the recording apparatus 11 is also called a front side, and the other end side opposite to the one end side is also called a rear side. One end side in the width direction X as viewed from the front side is also called a right side, and the other end side is also called a left side. Note that the conveyance direction on the path on which the medium is conveyed varies depending on the position on the path.

### Overall Configuration of Recording Apparatus

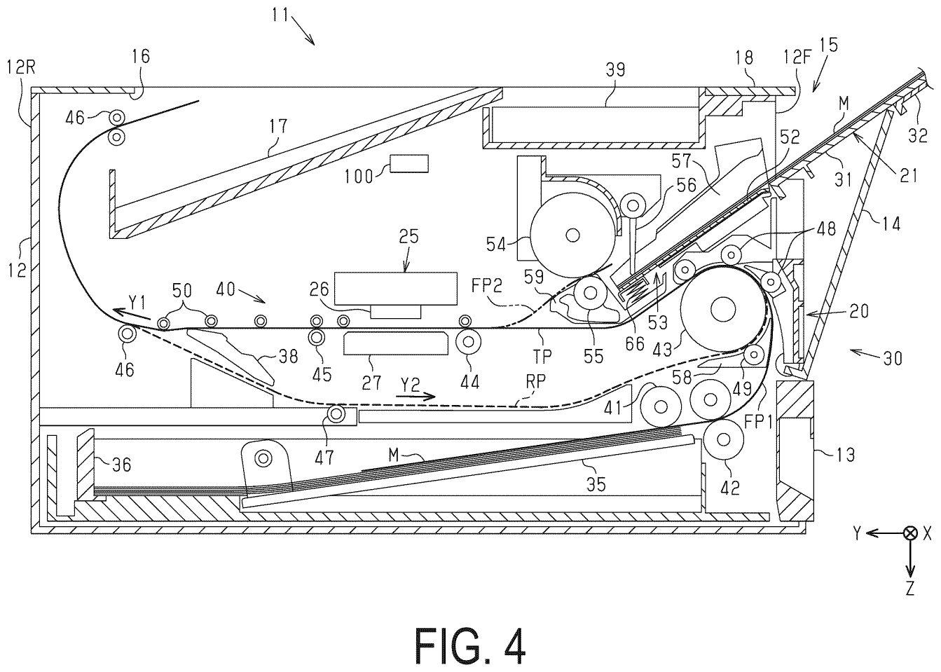

As illustrated in FIG. 1, the recording apparatus 11 is an apparatus configured to perform recording on a medium M (see FIG. 4). The recording apparatus 11 has a substantially cuboid shape. The recording apparatus 11 includes an apparatus body 12. The recording apparatus 11 may include a medium accommodation cassette 13, a front cover 14, a medium supply unit 15, a stacker 17, and a top cover 18.

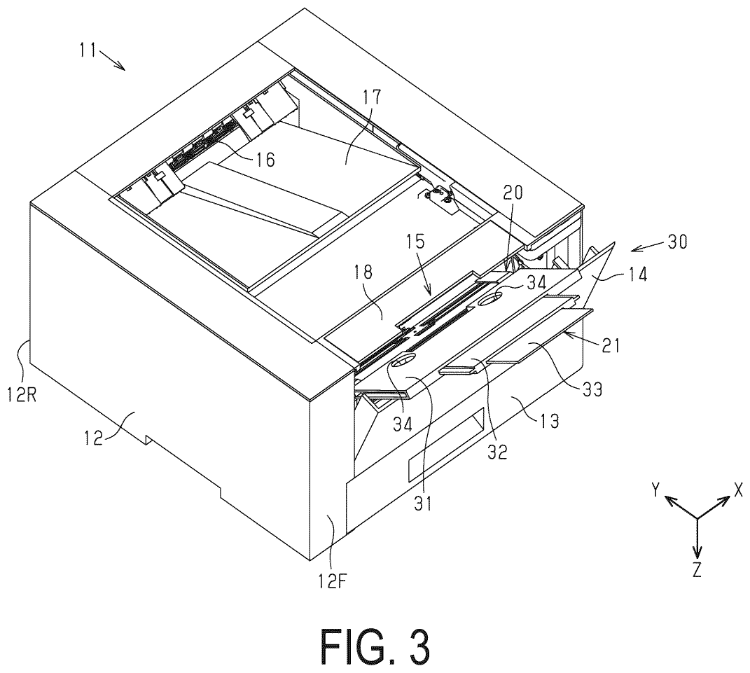

The medium accommodation cassette 13 and the medium supply unit 15 are supply sources of the medium M. The recording apparatus 11 performs recording on the medium M supplied from the medium accommodation cassette 13 or the medium supply unit 15. The medium M on which recording was performed is discharged from a discharge port 16 and loaded on the stacker 17. The medium supply unit 15 includes a support tray 21 (see FIG. 3) configured to support the medium M. The support tray 21 is stored inside the front cover 14 and the top cover 18. The top cover 18 is provided openably/closably on a front portion upper surface of the apparatus body 12.

The front cover 14 is provided on a front surface 12F of the apparatus body 12. The front cover 14 covers, from the front side, the support tray 21 in a stored state. The front cover 14 is disposed on the upper side of the medium accommodation cassette 13.

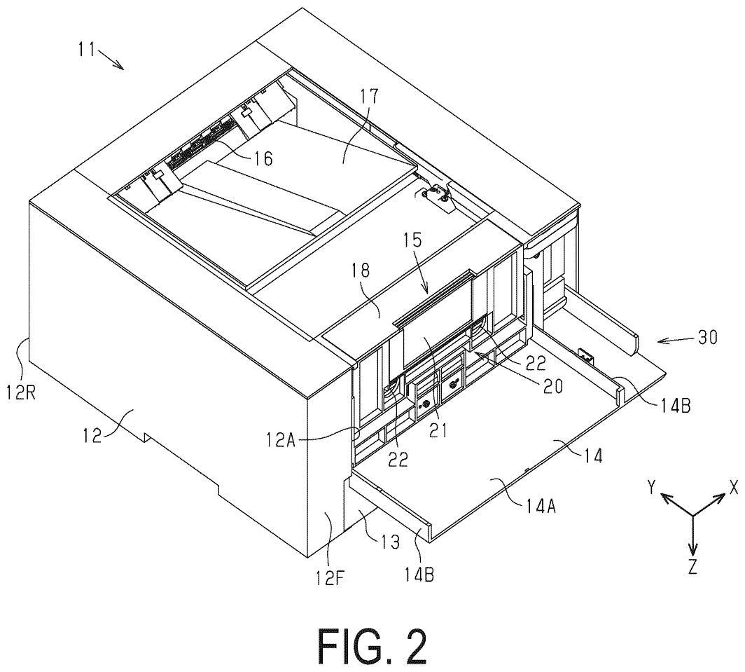

FIG. 2 illustrates the recording apparatus 11 in a state where the front cover 14 is opened. As illustrated in FIG. 2, the recording apparatus 11 includes a reverse path unit 20. In a state where the front cover 14 of the recording apparatus 11 is opened, the reverse path unit 20 is exposed. The reverse path unit 20 is mounted to an opening 12A provided in a front portion of the apparatus body 12. The reverse path unit 20 includes the support tray 21. The support tray 21 is exposed by bringing the front cover 14 in an open state.

The reverse path unit 20 is configured to be attachable/detachable to/from the apparatus body 12. In the present embodiment, the recording apparatus 11 includes a medium conveyance apparatus 30. The medium conveyance apparatus 30 includes the apparatus body 12 and the reverse path unit 20 detachably mounted to the apparatus body 12.

The reverse path unit 20 includes an operation unit 22 on a front surface thereof. The reverse path unit 20 is locked to the apparatus body 12 in the mounted state illustrated in FIG. 2. That is, the reverse path unit 20 is locked in the mounted state. The operation unit 22 is operated to attach/detach the reverse path unit 20 to/from the apparatus body 12. The operation unit 22 is operated to unlock the reverse path unit 20 from the apparatus body 12. In the example illustrated in FIG. 2, the reverse path unit 20 includes two operation units 22.

The medium accommodation cassette 13 is provided below the reverse path unit 20. In the present description, “below” refers to a downward part lower than a position having a height when the recording apparatus 11 is placed on a horizontal plane with the height being in the vertical direction Z parallel to the gravity direction. Therefore, as long as it is low in height, “below” includes immediately below and obliquely below. The medium accommodation cassette 13 is configured to be drawable in a direction from a rear surface 12R toward the front surface 12F of the apparatus body 12. The medium accommodation cassette 13 is mounted to the apparatus body 12 by being moved in a direction from the front surface 12F toward the rear surface 12R of the apparatus body 12.

The front cover 14 is movable in a range between a closed position illustrated in FIG. 1 and an open position illustrated in FIG. 2. As illustrated in FIG. 2, the front cover 14 assumes an open posture in a substantially horizontal state. The front cover 14 in the open posture is disposed below the reverse path unit 20. Specifically, the inner surface of the front cover 14 includes a planar surface 14A having a width slightly larger than a width range of the reverse path unit 20 in the width direction X. At least the planar surface 14A of the inner surface of the front cover 14 in the open posture is disposed below the reverse path unit 20. The front cover 14 includes two extension portions 14B extending perpendicularly to the planar surface 14A on both sides across the planar surface 14A in the width direction X.

The front cover 14 is openable/closable by pivot. The front cover 14 pivots about the lower end. The front cover 14 is pivotable about a pivot axis parallel to the width direction X. The front cover 14 is restricted from moving in an open direction at the open position illustrated in FIG. 2. By this restriction, the front cover 14 is held in an open posture that is substantially horizontal at the open position. Note that the term substantially horizontal may be any angle at which the angle formed with the horizontal plane is not limited to 0 degrees, and as long as it does not interfere with drawing of the reverse path unit 20 and can receive the reverse path unit 20 accidentally dropped by the user. For example, a range where the angle formed with the horizontal plane is within +10 degrees is included in the term substantially horizontal.

In the open position of the front cover 14, the reverse path unit 20 can be attached/detached. In an unlocked state with respect to the apparatus body 12, the reverse path unit 20 is configured to be removable in a path passing above the front cover 14 in the open posture. The reverse path unit 20 mounted on a front portion of the apparatus body 12 is configured to be drawable in a direction from the rear surface 12R toward the front surface 12F. The reverse path unit 20 can be drawn out in a forward direction −Y through a passage passing above the planar surface 14A while being guided in the width direction X by the pair of left and right extension portions 14B.

Note that the front cover 14 may be biased by a biasing force of a spring (not illustrated) in a close direction from the open position to the closed position. In this case, the front cover 14 may be held in the horizontal open posture by being locked to the apparatus body 12 at the open position.

FIG. 3 illustrates the recording apparatus 11 in which the support tray 21 is in a used state at the time of recording. As illustrated in FIG. 3, the support tray 21 includes a first tray 31 and a second tray 32. The second tray 32 is configured to be switchable between a drawn state where the second tray is drawn out from the first tray 31 and a stored state where the second tray is stored in the first tray 31. The support tray 21 may further include a third tray 33. That is, the support tray 21 may include the three trays 31 to 33 that are slidably coupled. The three trays 31 to 33 are the first tray 31, the second tray 32, and the third tray 33 in this order from a base end side. The width sizes of the first tray 31, the second tray 32, and the third tray 33 are gradually reduced in this order. The second tray 32 is coupled to the first tray 31 slidably in an extension/contraction direction. The third tray 33 is coupled to the second tray 32 slidably in the extension/contraction direction.

In the used state illustrated in FIG. 3, the support tray 21 is used, for example, in a state where the three trays 31 to 33 are drawn in the extension/contraction direction. When the user lifts the support tray 21 by a predetermined amount from the storage position while keeping a vertical posture and then tilts the support tray 21 rearward, the support tray 21 can be disposed in an inclined posture inclined at a predetermined inclination angle. That is, the support tray 21 is held in an inclined posture inclined at a predetermined angle illustrated in FIG. 3 with respect to the apparatus body 12. In the process of this operation, the user opens the front cover 14 or the top cover 18 as necessary. The support tray 21 in the inclined posture may be supported by an upper end portion of the front cover 14 that is slightly opened. The user draws out the three trays 31 to 33 constituting the support tray 21 to a necessary length. The user opens the top cover 18 to set the medium M in the medium supply unit 15. The medium M that is set is supported by the support tray 21.

### Internal Configuration of Recording Apparatus 11

Next, an internal configuration of the recording apparatus 11 will be described with reference to FIG. 4. In FIG. 4, the support tray 21 is in a used state. As illustrated in FIG. 4, the recording apparatus 11 includes the medium conveyance apparatus 30 and a recording unit 25 configured to perform recording on the medium M conveyed by the medium conveyance apparatus 30. The recording apparatus 11 includes a conveyance unit 40 and the recording unit 25 in the apparatus body 12. The conveyance unit 40 conveys the medium M. Note that the reverse path unit 20 includes a part of the medium supply unit 15 and a part of the conveyance unit 40. The recording apparatus 11 includes a control unit 100. The control unit 100 controls the recording apparatus 11. Specifically, the control unit 100 controls the conveyance unit 40, the recording unit 25, the medium supply unit 15, and the like.

As illustrated in FIG. 4, the conveyance unit 40 conveys the medium M along paths TP, RP, FP1, and FP2. The paths of the medium M include a first feed path FP1, a second feed path FP2, a conveyance path TP, and a reverse path RP. In FIG. 4, the conveyance path TP is indicated by a thick line. The conveyance path TP is a path through which the conveyance unit 40 conveys the medium M from the medium accommodation cassette 13. The conveyance path TP includes the first feed path FP1. The first feed path FP1 is a path through which the medium M is supplied from the medium accommodation cassette 13.

In FIG. 4, the reverse path RP is indicated by a thick broken line. The reverse path RP is a path through which the medium M on which the recording of a first surface (front surface) was completed is reversed when double-sided recording is performed. In FIG. 4, the second feed path FP2 is indicated by a two-dot chain line. The second feed path FP2 is a path through which the medium supply unit 15 supplies the medium M supported by the support tray 21. The second feed path FP2 joins the conveyance path TP at a position more upstream in the conveyance direction Y than the recording position of the recording unit 25. Note that hereinafter, a direction in which the medium M is conveyed toward the discharge port 16 along the conveyance path TP is called a first conveyance direction Y1. A direction in which the medium M is conveyed along the reverse path RP is called a second conveyance direction Y2.

As illustrated in FIG. 4, the medium accommodation cassette 13 includes a placement plate 35 on which the medium M can be placed. On the placement plate 35, a plurality of media M can be placed in a stacked state. The medium accommodation cassette 13 includes an edge guide portion 36 configured to position the plurality of media M placed on the placement plate 35. The placement plate 35 is tiltably supported in a state of being biased upward. When the medium accommodation cassette 13 is mounted to the apparatus body 12, the placement plate 35 tilts upward by the biasing force.

The conveyance unit 40 includes a plurality of rollers arranged along the conveyance path TP. Specifically, the conveyance unit 40 includes a first feed roller 41, a separation roller pair 42, a reverse roller 43, a conveyance roller pair 44, a discharge roller pair 45, and a discharge roller 46. The conveyance unit 40 includes a conveyance roller 47 configured to convey the medium M along the reverse path RP. Furthermore, the conveyance unit 40 includes a plurality of guide rollers 48 and 49 arranged along the outer periphery of the reverse roller 43. The guide rollers 48 and 49 are driven rollers. The conveyance unit 40 includes a plurality of guide rollers 50 configured to guide the medium M along the conveyance path TP.

The first feed roller 41 is disposed above a downstream end portion in a medium supply direction of the medium accommodation cassette 13. The uppermost one of the plurality of media M loaded on the placement plate 35 in the medium accommodation cassette 13 comes into contact with the first feed roller 41. As the first feed roller 41 rotates, the medium M that is the uppermost one is fed from the medium accommodation cassette 13. The separation roller pair 42 is arranged at a position more downstream in a feed direction than the first feed roller 41. The separation roller pair 42 separates, into one sheet, the medium M fed from the first feed roller 41. This suppresses double feeding of the medium M.

The reverse roller 43 is disposed at a position more downstream in the feed direction than the separation roller pair 42. The reverse roller 43 is a roller having a diameter larger than that of the first feed roller 41. The plurality of guide rollers 48 are arranged along the outer peripheral surface of the reverse roller 43. The plurality of guide rollers 48 rotate following the rotation of the reverse roller 43 while nipping the medium M between the plurality of guide rollers 48 and the outer peripheral surface of the reverse roller 43. The reverse roller 43 rotates counterclockwise in FIG. 4. The medium M is conveyed in a path along the outer periphery of the reverse roller 43 in a state of being nipped between the reverse roller 43 and the plurality of guide rollers 48. Due to this, while being reversed, the medium M has the conveyance direction changed to the conveyance direction Y substantially opposite to the feed direction from the medium accommodation cassette 13. The medium M sent out from the reverse roller 43 is conveyed downstream in the conveyance direction Y toward the recording position of the recording unit 25.

The recording unit 25 performs recording on the medium M. The recording unit 25 performs recording on the medium M at a recording position on the conveyance path TP. The recording unit 25 is disposed at a position facing the conveyance path TP from above. The recording unit 25 includes a recording head 26 configured to perform recording on the medium M. The recording head 26 of the present embodiment may be a line recording type line head having a length corresponding to the maximum width of the medium M. The recording unit 25 of the line recording type performs recording on the medium M by simultaneously ejecting liquid such as ink from a plurality of nozzles over a range of the maximum width of the medium M toward the medium M conveyed at a constant conveyance speed by the conveyance unit 40. Note that the recording unit 25 may be a serial recording type. In the serial recording type, recording is performed on the medium M by alternately performing a conveyance action in which the conveyance unit 40 conveys the medium M to the next recording position and a recording action in which the recording unit 25 records one line (one path) on the medium M while moving in the width direction X (scanning direction).

A support unit 27 is disposed at a position facing the recording unit 25 across the conveyance path TP. The support unit 27 is, for example, a platen. The recording head 26 performs recording on the medium M supported by the support unit 27. The support unit 27 supports a part present at the recording position of the medium M. The recording unit 25 performs recording on the medium M at a part supported by the support unit 27.

The medium supply unit 15 supplies the medium M supported by the support tray 21. The medium supply unit 15 includes a placement unit 52, a hopper unit 53, a supply roller 54, a separation roller 55, a medium detection unit 56, and an edge guide 57.

The placement unit 52 is disposed at a part between the support tray 21 and the supply roller 54. On the placement unit 52, the medium M supported by the support tray 21 is placed. On the placement unit 52, a downstream part in the supply direction of the medium M supported by the support tray 21 is placed. The placement unit 52 is disposed in a posture inclined at an inclination angle matching the inclination angle of the support tray 21 when in use. The placement unit 52 is supported tiltably with the upper end side as a fulcrum. The placement unit 52 can change the inclined posture between a standby position illustrated in FIG. 4 and a feeding position tilted upward from the standby position. The edge guide 57 is operated when the medium M placed on the placement unit 52 is positioned in the width direction X.

The hopper unit 53 is disposed on a lower side of the placement unit 52. The hopper unit 53 switches the inclination angle of the placement unit 52. The hopper unit 53 has a function of pushing up the placement unit 52 from the standby position to the feeding position illustrated in FIG. 4 at the time of feeding the medium M. The hopper unit 53 is driven via a cam (not illustrated) by power of a supply motor (not illustrated) that is a drive source of the supply roller 54. When the supply roller 54 starts rotating, the cam releases the locking of the placement unit 52 at the standby position. The placement unit 52 moves from the standby position to the feeding position by a biasing force of a spring 66 constituting the hopper unit 53. The medium M on the placement unit 52 moved to the feeding position is pressed against the supply roller 54.

In this state, the supply roller 54 rotates in the clockwise direction in FIG. 4. The supply roller 54 and the separation roller 55 rotate while nipping the medium M that is the uppermost supported by the support tray 21, thereby supplying the medium M one by one. The separation roller 55 separates, into one sheet, the medium M supplied by the supply roller 54.

Before the supply roller 54 finishes one rotation, a leading end portion of the medium M fed along the second feed path FP2 reaches a position nipped by the conveyance roller pair 44. When the supply roller 54 finishes one rotation, the placement unit 52 returns from the feeding position to the standby position via the cam. The medium M to be fed next time or after on the placement unit 52 is separated from the supply roller 54. In this manner, the medium M on the placement unit 52 is fed one by one by the rotation of the supply roller 54 and the drive of the hopper unit 53 in conjunction with the rotation of the supply roller 54. The conveyance roller pair 44 conveys the medium M that is nipped to the downstream in the conveyance direction Y toward the recording position of the recording unit 25.

Note that the medium detection unit 56 detects the presence/absence of the medium M on the placement unit 52. Upon receiving a recording execution instruction, the control unit 100 rotates the supply roller 54 by drive of the supply motor if the medium detection unit 56 detects the medium M on the placement unit 52 at that time. The control unit 100 does not rotate the supply roller 54 unless the medium detection unit 56 detects the medium M on the placement unit 52.

Next, conveyance of the medium M and recording on the medium M in the recording apparatus 11 will be described. Hereinafter, single-sided recording and double-sided recording will be described in order. First, single-sided recording will be described. The medium M is conveyed from the medium accommodation cassette 13 along the conveyance path TP indicated by the thick line in FIG. 4. The recording unit 25 performs recording on the medium M at a recording position midway in the conveyance path TP. The medium M after recording is conveyed along the conveyance path TP from the recording position and discharged from the discharge port 16. The medium M after recording discharged from the discharge port 16 is loaded on the stacker 17. On the other hand, when the medium M is fed from the medium supply unit 15, the medium M supported by the support tray 21 is fed by the supply roller 54. The medium M fed along the second feed path FP2 reaches the conveyance path TP. Thereafter, the recording unit 25 performs recording on the medium M at the recording position on the conveyance path TP, and then the medium M after recording is discharged from the discharge port 16. The medium M after recording that is discharged is loaded on the stacker 17.

Next, double-sided recording will be described. When performing double-sided recording, recording on the first surface (front surface) of the medium M is performed similarly to that in the case of single-sided recording described above. The control unit 100 switches the conveyance direction to the opposite direction by reversely rotating the discharge roller 46 midway in discharging, from the discharge port 16, the medium M having the first surface recorded. Specifically, the control unit 100 recognizes the position of the medium M on the conveyance path TP. The control unit 100 recognizes the position of the medium M on the conveyance path TP based on a sensing result of a sensor that senses the medium M at a predetermined position on the conveyance path TP and a conveyance amount of the medium M from the sensed position. When the rear end of the medium M on which recording was performed passes a branching position between the conveyance path TP and the reverse path RP to the downstream in the conveyance direction Y, the control unit 100 switches the conveyance direction of the medium M to the opposite direction.

The recording apparatus 11 includes a flap 38 at a branching place between the conveyance path TP and the reverse path RP. The flap 38 can select the path of the medium M at the branching position. The flap 38 guides, to the reverse path RP, the medium M reversely conveyed in the direction opposite to the first conveyance direction Y1.

The reverse path RP is disposed in a path passing through the lower side of the conveyance path TP. The reverse path RP is a path through which the medium M is conveyed in the second conveyance direction Y2 from the branching position to an inlet to the reverse roller 43. The medium M guided to the reverse path RP is sent to a position where the rear end of the medium M passes the conveyance roller 47 by the rotation of the discharge roller 46. The medium M after the leading end is separated from the discharge roller 46 is conveyed in the second conveyance direction Y2 along the reverse path RP by the rotation of the conveyance roller 47.

Upon reaching the inlet of the reverse roller 43, the rear end of the medium M conveyed along the reverse path RP is nipped by the reverse roller 43 and the guide roller 49. When the reverse roller 43 rotates in this state, the medium M is conveyed along the path of the outer periphery of the reverse roller while joining the first feed path FP1. In this manner, the front and back of the medium M on which the recording of the first surface was finished are reversed. The medium M that is reversed is conveyed in the first conveyance direction Y1 along the conveyance path TP. The recording unit 25 performs recording on the second surface of the medium M at a recording position midway in the conveyance path TP. Thus, the recording is performed on both sides of the medium M. The medium M on which recording is performed on both sides is conveyed along the conveyance path TP and then discharged from the discharge port 16. The medium M after double-sided recording that is discharged is loaded on the stacker 17.

Note that in the recording apparatus 11 of the present embodiment, a waste liquid accommodation unit 39 is disposed at a position above the medium supply unit 15. The user can perform an operation of attaching/detaching the waste liquid accommodation unit 39 at a position on the upper side of the front portion of the recording apparatus 11. The waste liquid accommodation unit 39 accommodates, as waste liquid, liquid such as ink forcibly discharged from the nozzle of the recording head 26 through maintenance by a maintenance apparatus (not illustrated). The liquid discharged from the recording head 26 by the maintenance apparatus is collected in the waste liquid accommodation unit 39 through a waste liquid tube (not illustrated).

### Configuration of Reverse Path Unit 20

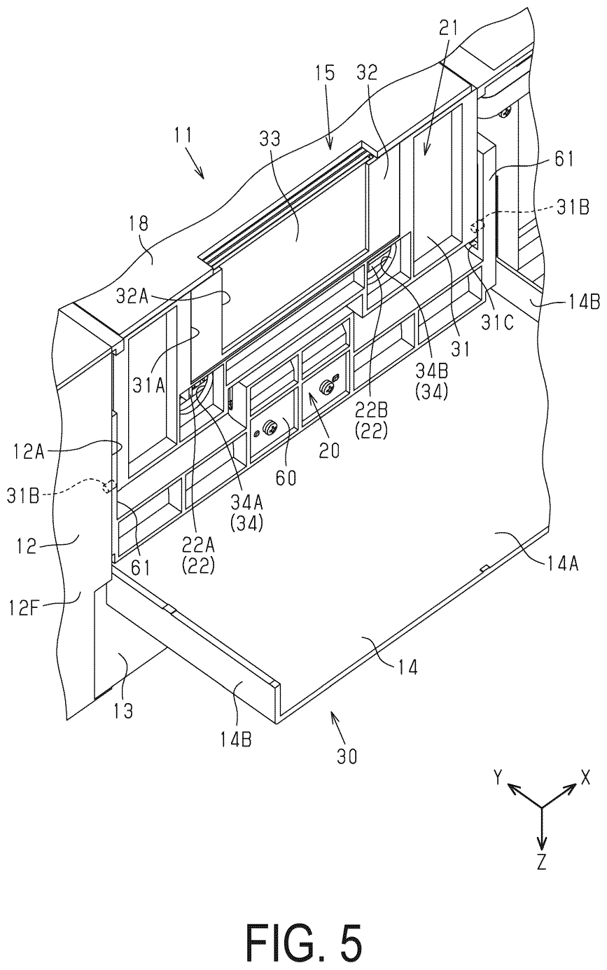

Next, the configuration of the reverse path unit 20 will be described with reference to FIG. 5. FIG. 5 illustrates the front surface of the reverse path unit 20 exposed when the front cover 14 is in the open posture. The reverse path unit 20 includes a base 60 and the support tray 21 disposed on the upper side of the base 60. The support tray 21 illustrated in FIG. 5 is in a stored state. In the support tray 21, the first tray 31, the second tray 32, and the third tray 33 are arranged in this order in the depth direction Y from the front surface to the back surface. The second tray 32 is stored in a recess portion 31A of the first tray 31. The third tray 33 is stored in a recess portion 32A of the second tray 32.

The first tray 31 includes an opening portion 34. In a state where the support tray 21 is in a stored state, the opening portion 34 may be provided below the second tray 32 in the first tray 31. The opening portion 34 may be positioned on a lower side of the recess portion 31A of the first tray 31. Two opening portions 34 may be provided on the left and right. That is, the first tray 31 may include the two opening portions 34 on the lower side of the recess portion 31A. The two opening portions 34 may be arranged at line-symmetric positions with respect to a width center line of the support tray 21 in the width direction X. Since the two opening portions 34 are configured to open to the first tray 31, the open positions thereof are not restricted by the size in the width direction X of the support tray 21.

The reverse path unit 20 includes a first operation unit 22A and a second operation unit 22B as the operation unit 22. The reverse path unit 20 includes, as the opening portion 34, a first opening portion 34A corresponding to the first operation unit 22A and a second opening portion 34B corresponding to the second operation unit 22B. Note that hereinafter, when the first operation unit 22A and the second operation unit 22B are not distinguished from each other, they are simply called the “operation unit 22”. When the first opening portion 34A and the second opening portion 34B are not distinguished from each other, they are simply called the “opening portion 34”.

The reverse path unit 20 includes the operation unit 22 at a position behind the opening portion 34. The two operation units 22 are arranged at positions behind the two opening portions 34, respectively. As illustrated in FIG. 5, in a state where the front cover 14 is in the open posture, the two operation units 22 are exposed from the two opening portions 34. Therefore, when the front cover 14 is opened, the user can visually recognize the operation unit 22 exposed from the opening portion 34. The two operation units 22 are provided at positions corresponding to the two opening portions 34 formed in the first tray 31. Therefore, the two operation units 22 are arranged at positions easily operated with an appropriate interval in the width direction X without being restricted in position by the size in the width direction X of the support tray 21. The two operation units 22 are arranged at positions at an interval where an adult can perform an operation using two fingers with one hand, for example.

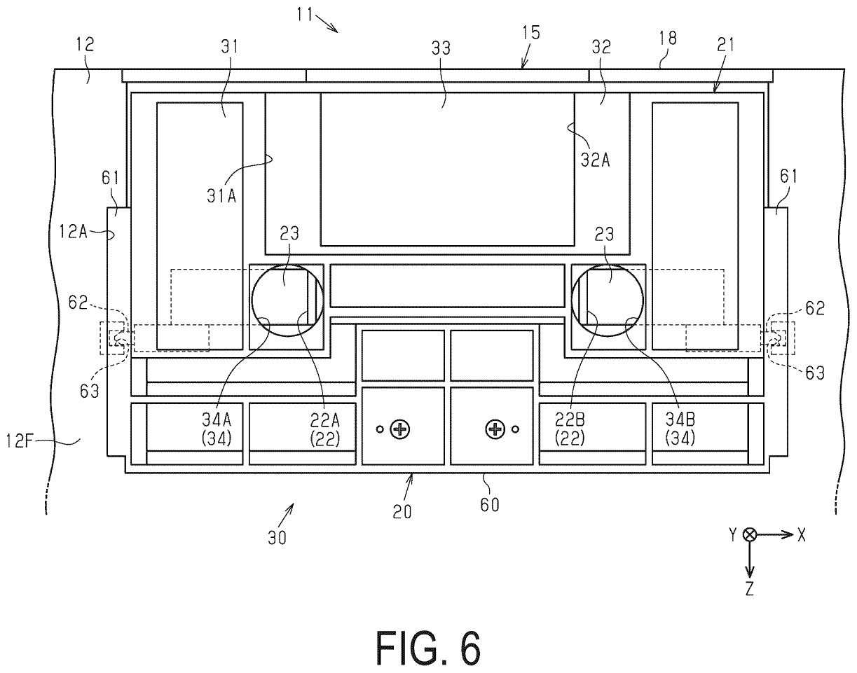

As illustrated in FIG. 6, the two operation units 22 are formed at respective end portions of two slide members 23 extending outside in the width direction X from the positions of the opening portions 34, respectively. The operation unit 22 may be formed by a part bent in an L shape at the end portion of the slide member 23. The two slide members 23 are biased in directions opposite to each other toward the outside in the width direction X, respectively, by an elastic force of a spring (not illustrated). The end portion of the slide member 23 on the side where the operation unit 22 is positioned is defined as a first end portion. The slide member 23 is provided with a locking portion 62 at a second end portion, which is an end portion opposite to the first end portion. In the mounted state illustrated in FIG. 5 in which the reverse path unit 20 is mounted to the apparatus body 12, a position on the apparatus body 12 side corresponding to the locking portion 62 is provided with a locked portion 63. The reverse path unit 20 in the mounted state illustrated in FIG. 5 is locked with respect to the apparatus body 12 by locking between the locking portion 62 and the locked portion 63. In the example illustrated in FIG. 6, the locking portion is a locking projection, and the locked portion 63 is a locked recess portion. Note that the locking portion 62 may be a locked recess portion, and the locked portion 63 may be a locking projection.

In the mounted state illustrated in FIG. 6, the user operates the operation unit 22 via the opening portion 34 with two fingers of one hand. The user presses the two operation units 22 in a direction approaching the width direction X. Due to this, the locking portion 62 is separated from the locked portion 63, thereby unlocking the reverse path unit 20 with respect to the apparatus body 12. Then, the user draws out the reverse path unit 20 in the forward direction −Y while holding the two operation units 22 with the two fingers that performed the unlock operation.

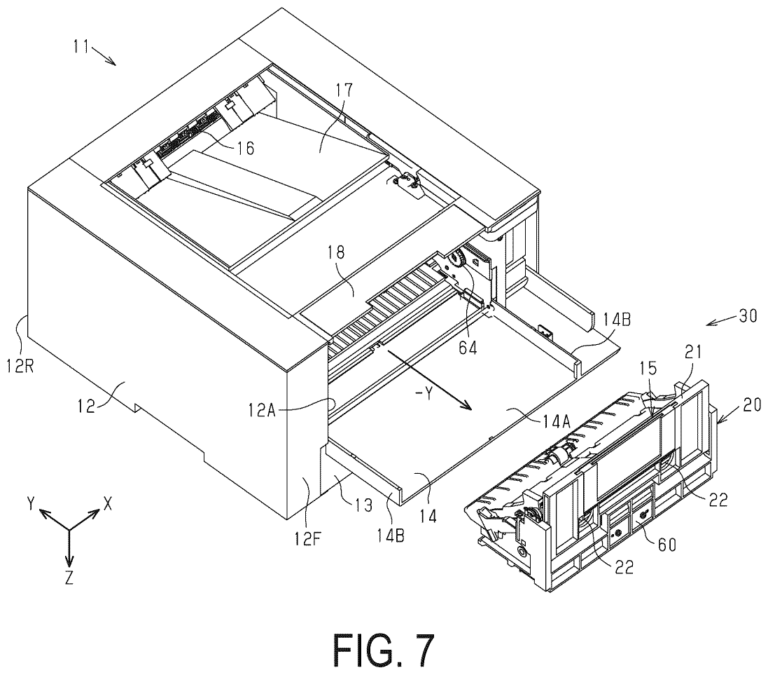

As illustrated in FIG. 7, the reverse path unit 20 is drawn out in the forward direction −Y from the apparatus body 12. The reverse path unit 20 is drawn out from the apparatus body 12 through above the planar surface 14A of the inner surface of the front cover 14. During this drawing out process, the position in the width direction X of the reverse path unit 20 is restricted by the two extension portions 14B of the front cover 14. Therefore, the reverse path unit 20 can be drawn out straight in the forward direction −Y.

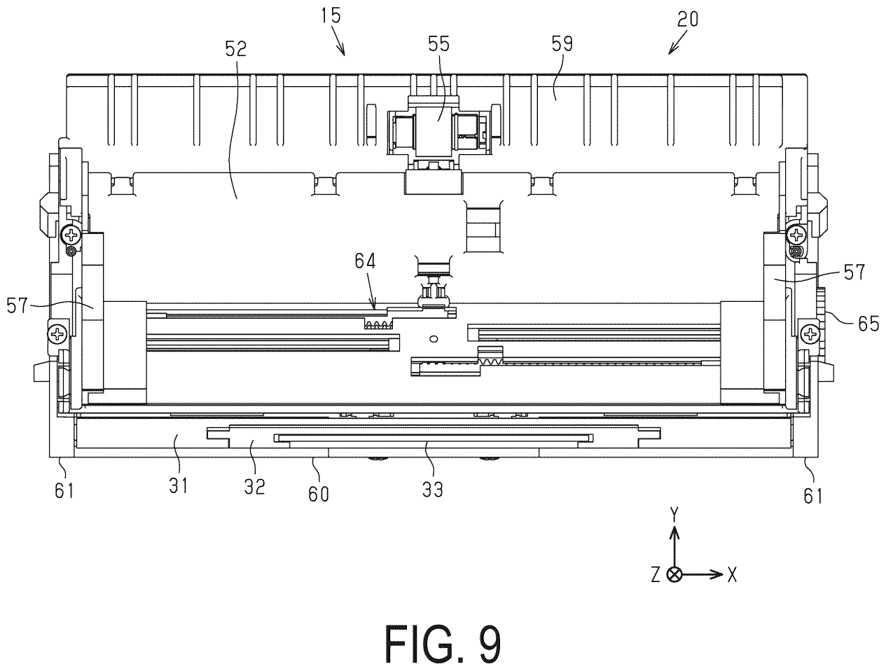

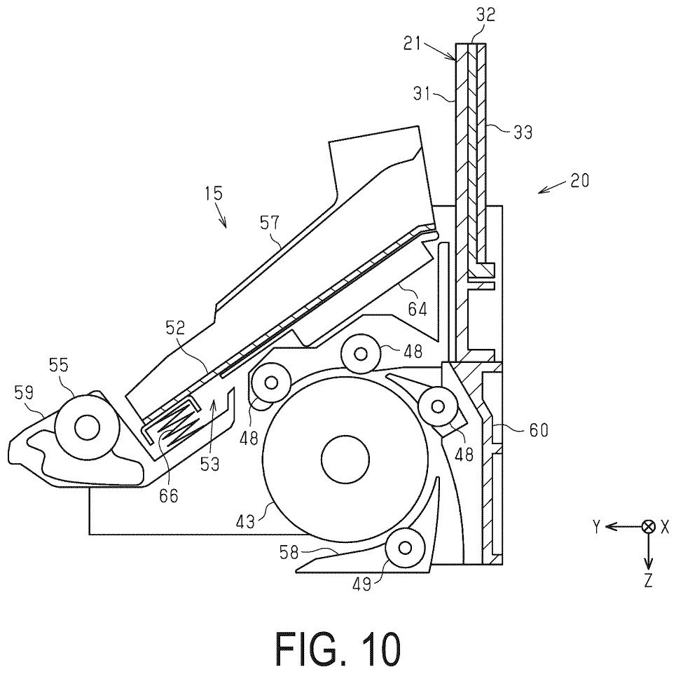

As illustrated in FIG. 7, a driving gear 64 configured to be engaged with a driven gear 65 (see FIGS. 4 and 9) on the reverse path unit 20 side is disposed on an inner side surface more behind than the opening 12A of the apparatus body 12. The driving gear 64 is rotatable by power of a conveyance motor (not illustrated), for example. When the reverse path unit 20 is mounted to the opening 12A of the apparatus body 12, the driven gear 65 is engaged with the driving gear 64. The reverse roller 43 (see FIG. 10) rotates by the power of the conveyance motor being transmitted via the engagement between the driving gear 64 and the driven gear 65.

### Detailed Configuration of Reverse Path Unit 20

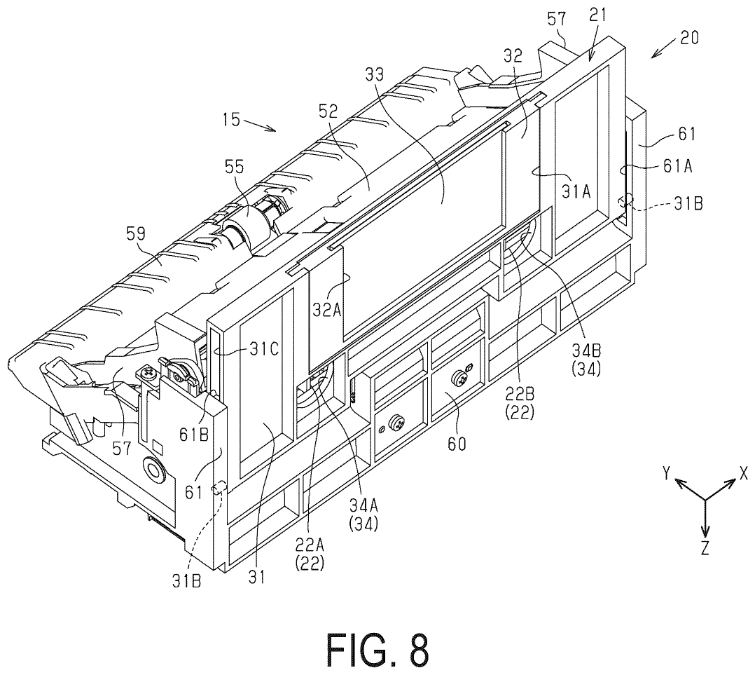

Next, a detailed configuration of the reverse path unit 20 will be described with reference to FIGS. 8 to 10. FIG. 8 is a perspective view of the reverse path unit 20. FIG. 8 is a plan view of the reverse path unit 20. FIG. 9 is a side cross-sectional view of the reverse path unit 20.

As illustrated in FIGS. 8 and 9, the reverse path unit 20 includes the base 60, the support tray 21, the hopper unit 53, the placement unit 52, a medium guide unit 59, and the separation roller 55. As illustrated in FIG. 10, the reverse path unit 20 includes the reverse roller 43, the plurality of guide rollers 48, the guide roller 49 dedicated to reverse, and a path formation unit 58. The base 60 includes a metal frame and a synthetic resin member.

As illustrated in FIGS. 8 and 9, the base 60 supports the support tray 21, the placement unit 52, and the medium guide unit 59. The separation roller 55 is rotatably supported at a substantially center position in the width direction X of the medium guide unit 59.

As illustrated in FIG. 10, the base 60 supports the hopper unit 53, the reverse roller 43, the plurality of guide rollers 48, and the path formation unit 58. The path formation unit 58 is a member configured to form a part of the first feed path FP1 and a part of the reverse path RP. The guide roller 49 dedicated to reverse is supported by the path formation unit 58.

As illustrated in FIGS. 8 and 9, the base 60 supports the support tray 21 at a front portion thereof. The base 60 includes a pair of holding portions 61 extending upward on both sides of the support tray 21 in a stored state. The support tray 21 includes two shaft portions 31B at lower ends of side surfaces on both sides in the width direction X. The two shaft portions 31B protrude outward in the width direction X. The pair of holding portions 61 have guide grooves 61A extending along the vertical direction Z on the inner side surface facing the support tray 21. The support tray 21 is held movably in the vertical direction Z with respect to the pair of holding portions 61 by inserting the two shaft portions 31B into the two guide grooves 61A. Each of the pair of holding portions 61 includes one shaft portion 61B on the upper side of the guide groove 61A. The first tray 31 includes two guide grooves 31C extending along the vertical direction Z in the stored state illustrated in FIG. 8 on the side surfaces on both sides. The support tray 21 is held movably in the vertical direction Z with respect to the pair of holding portions 61 by inserting the two shaft portions 61B into the two guide grooves 31C.

The support tray 21 slides up and down while maintaining a vertical posture in a range where the shaft portions 31B and 61B are guided in the guide grooves 61A and 31C. Upon rising to a predetermined height with respect to the holding portion 61, the support tray 21 can tilt rearward by one of the shaft portions 31B and 61B being detached from one of the guide grooves 61A and 31C. The support tray 21 is restricted at an inclination angle substantially the same as the inclination of the placement unit 52. That is, the support tray 21 is held in the inclined posture. Note that even when the support tray 21 tilts backward, the engagement state with the pair of holding portions 61 is held.

On the placement unit 52, the medium M supported by the support tray 21 is placed. The medium guide unit 59 is disposed at a rear position of the placement unit 52. The medium guide unit 59 guides the medium M fed by the supply roller 54. The inclination angle of the medium guide unit 59 with respect to the horizontal plane is substantially equal to the inclination angle of the placement unit 52. The separation roller 55 protrudes slightly upward from the upper surface of the medium guide unit 59. The second feed path FP2 along the guide surface of the medium guide unit 59 joins the conveyance path TP at an acute angle. The medium M supplied by the supply roller 54 is smoothly sent to the conveyance path TP through the second feed path FP2.

### Actions of Embodiment

Next, actions of the recording apparatus 11 and the medium conveyance apparatus 30 will be described.

When a jam or the like occurs in a front region in the apparatus body 12, the user removes the reverse path unit 20 from the apparatus body 12 to resolve the jam.

As illustrated in FIG. 2, the user first opens the front cover 14. The front cover 14 is held in a horizontal open posture at the open position. When the front cover 14 is opened to the open position, the user can visually recognize the operation unit 22 exposed from the opening portion 34. The user can decisively recognize the position of the operation unit 22. The opening portion 34 through which the operation unit 22 is exposed is formed in the first tray 31 constituting the support tray 21. Therefore, the interval in the width direction X of the operation unit 22 can be avoided from being restricted by the width size of the support tray 21, which is a problem in the configuration in which the operation unit 22 is disposed on both sides of the support tray 21 while avoiding the support tray 21. That is, in the present embodiment, the two operation units 22 are arranged at positions with an interval at which the user can easily operate without being restricted by the width size of the support tray 21.

The planar surface 14A of the inner surface of the front cover 14 at the open position is positioned lower than the bottom surface of the reverse path unit 20 in a mounted state. Therefore, when the front cover 14 is in the open posture, a space for a removal path of the reverse path unit 20 is secured.

Therefore, the user presses the two operation units 22 inward in the width direction X with the two fingers inserted from the two opening portions 34. That is, the user performs an operation in a direction approaching the width direction X with two fingers. As a result of this operation, the locking between the locking portion 62 and the locked portion 63 is released. That is, when the locking of both sides in width direction X of the reverse path unit 20 is released, the reverse path unit 20 is unlocked. The user horizontally draws out the reverse path unit 20 in the forward direction −Y as illustrated in FIG. 7 while holding the two operation units 22 with two fingers by the unlock operation. Due to this, the reverse path unit 20 is removed from the apparatus body 12. The reverse path unit 20 is drawn out in the forward direction −Y while the position in the width direction X is restricted by the two extension portions 14B in a path passing above the planar surface 14A of the front cover 14. At this time, the bottom surface of the reverse path unit 20 may slide on the inner surface of the front cover 14. In this manner, when the reverse path unit 20 is drawn out, the front cover 14 in the open posture is received from the lower side. Therefore, even if the user accidentally drops the reverse path unit 20 in the middle of drawing out the reverse path unit 20, the front cover 14 receives the reverse path unit 20. Therefore, occurrences of damages and failures due to dropping of the reverse path unit 20 can be suppressed.

The user removes the medium M that is jammed from the path. After the jam is resolved, the user mounts the reverse path unit 20 to the opening 12A of the apparatus body 12. When the reverse path unit 20 is mounted to the apparatus body 12, the locking portion 62 biased in the locking direction is locked to the locked portion 63. Due to this, the reverse path unit 20 is locked in the mounted state with respect to the apparatus body 12.

For example, in a known recording apparatus, a support width of a support tray is reduced when the interval between two operation units positioned on outside in the width direction of the support tray is narrowed. In this case, the left and right ends of the medium supported by the support tray having a narrow support width sag and deform. When such a medium is fed, inappropriate conveyance such as a jam or rubbing of the medium against a recording head is performed, and conveyance reliability is lowered.

On the other hand, in the medium conveyance apparatus 30 of the present embodiment, the two operation units 22 are laid out within the width of the support tray 21. Therefore, even if the width of the support tray 21 increases due to design needs or the like, the interval between the two operation units 22 can be set to an appropriate distance that can be operated by one hand of the user.

On the other hand, in the medium conveyance apparatus 30 of the present embodiment, the support tray 21 can be formed into a necessary support width even if the interval between the two operation units 22 is narrowed. Therefore, the medium M can be supported by the support tray 21 having a wide support width without sagging or deformation of the left and right ends. Therefore, when the medium M is fed, inappropriate conveyance such as a jam or rubbing of the medium M against the recording head 26 can be avoided, and conveyance reliability is improved.

For example, a configuration in which the operation unit is disposed at a position hidden by the support tray is also conceivable. In this case, since the operation unit is hidden by the support tray, it is difficult for the user to understand how to access the operation unit. Since it is necessary to perform an operation of drawing up the support tray up to a height at which the operation unit is exposed, the number of operations (number of actions) required until the reverse path unit is removed increases. When the recording apparatus is installed in a space having a narrow space on a top surface side, when the reverse path unit is removed, it is necessary to move the recording apparatus 11, which is difficult to use.

On the other hand, in the medium conveyance apparatus 30 of the present embodiment, the operation unit 22 is exposed from the opening portion 34 without being hidden by the support tray 21. Therefore, since the visibility of the operation unit 22 is high, it is easy to understand the access method when removing the reverse path unit 20. The operation unit 22 can be visually recognized and operated without drawing up the support tray 21. Since an extra operation is unnecessary, the number of operations (number of actions) required to remove the reverse path unit 20 is reduced.

Furthermore, since the reverse path unit 20 can be attached/detached without moving the support tray 21, the recording apparatus 11 can be installed even in a place where the space on the top surface side is narrow. Since the reverse path unit 20 can be attached/detached without moving the support tray 21, consideration to avoid collision of the support tray 21 with the hand during operation is unnecessary.

### Effects of Embodiment

Therefore, according to this embodiment, the following effects can be obtained.

(1) The medium conveyance apparatus 30 includes the apparatus body 12 and the reverse path unit 20. The reverse path unit 20 includes the reverse roller 43 configured to reverse the medium M, and is configured to be attachable/detachable to/from the apparatus body 12. The reverse path unit 20 includes the support tray 21, the operation unit 22, and the opening portion 34. The support tray 21 can be switched between the drawn state where the support tray 21 is drawn out from the reverse path unit 20 and the stored state where the support tray 21 is stored in the reverse path unit 20. The support tray 21 is configured to support the medium M to be fed in the drawn state. The operation unit 22 is operated to attach/detach the reverse path unit 20 to/from the apparatus body 12. The opening portion 34 is provided in the support tray 21 and configured to enable operation of the operation unit 22. According to this configuration, by providing the support tray 21 with the opening portion 34 through which the operation unit 22 can be accessed, the operation unit 22 can be disposed at an appropriate position regardless of the size in the width direction X of the support tray 21. Therefore, the reverse path unit 20 can be easily attached/detached.

(2) The support tray 21 includes the first tray 31 and the second tray 32. The second tray 32 is configured to be switchable between the drawn state where the second tray is drawn out from the first tray 31 and the stored state where the second tray is stored in the first tray 31. The opening portion 34 is provided in the first tray 31 and is provided below the second tray 32 when the support tray 21 is in the stored state. According to this configuration, the operation unit 22 can be disposed at an appropriate position regardless of the size in the width direction X of the second tray 32.

(3) The operation unit 22 includes the first operation unit 22A and the second operation unit 22B. The opening portion 34 includes the first opening portion 34A corresponding to the first operation unit 22A and the second opening portion 34B corresponding to the second operation unit 22B. According to this configuration, it is easy to avoid the two operation units 22 from being separated too much in the width direction X of the support tray 21. The two operation units 22 can be arranged at positions where they are easily operated. Therefore, the reverse path unit 20 can be easily attached/detached.

(4) The medium conveyance apparatus 30 further includes the medium accommodation cassette 13 and the front cover 14. The medium accommodation cassette 13 is provided below the reverse path unit 20, and is configured to be drawable in a direction from the rear surface 12R toward the front surface 12F of the apparatus body 12. The front cover 14 is provided on the front surface 12F of the apparatus body 12. The support tray 21 is exposed by bringing the front cover 14 in an open state. According to this configuration, by covering the reverse path unit 20 drawn out from the front surface 12F with the front cover 14, a decrease in visibility of the operation unit 22 can be reduced as compared with a configuration in which the opening portion is covered with the cover. That is, the user who has opened the front cover 14 can immediately visually recognize the operation unit 22 exposed from the opening portion 34. It is possible to suppress intrusion of dust or the like into the apparatus body 12 via the opening portion 34. Furthermore, the front surface of the reverse path unit 20 lacks designability because ribs and screws are exposed. By covering the front surface of the reverse path unit 20 with the front cover 14, the designability of the front surface of the recording apparatus 11 is enhanced.

(5) The front cover 14 assumes an open posture in a substantially horizontal state. The front cover 14 in the open posture is disposed below the reverse path unit 20. According to this configuration, even if the reverse path unit 20 is accidentally dropped from the hand when being attached/detached, the front cover 14 supports the reverse path unit 20, whereby it is possible to prevent failures due to dropping of the reverse path unit 20 from a position higher than the cassette.

(6) The medium conveyance apparatus 30 includes a cover 75 configured to cover the opening portion 34 in an openable/closable state. According to this configuration, it is possible to suppress dust or the like from intruding into the apparatus body 12 from the opening portion 34.

(7) The reverse path unit 20 includes the supply roller 54 configured to supply the medium M supported by the support tray 21. According to this configuration, the supply roller 54 can also be integrally attached/detached. For example, it is easy to remove the medium M clogged in the supply roller 54 when a jam occurs. For example, when the supply roller 54 needs to be replaced due to wear or the like, the supply roller is easily replaced.

(8) The recording apparatus 11 includes the medium conveyance apparatus 30 and the recording unit 25 configured to perform recording on the medium M conveyed by the medium conveyance apparatus 30. According to this configuration, according to the recording apparatus 11, the operation unit 22 can be disposed at an appropriate position regardless of the size in the width direction X of the support tray 21. This facilitates attachment/detachment of the reverse path unit 20.

### Modifications

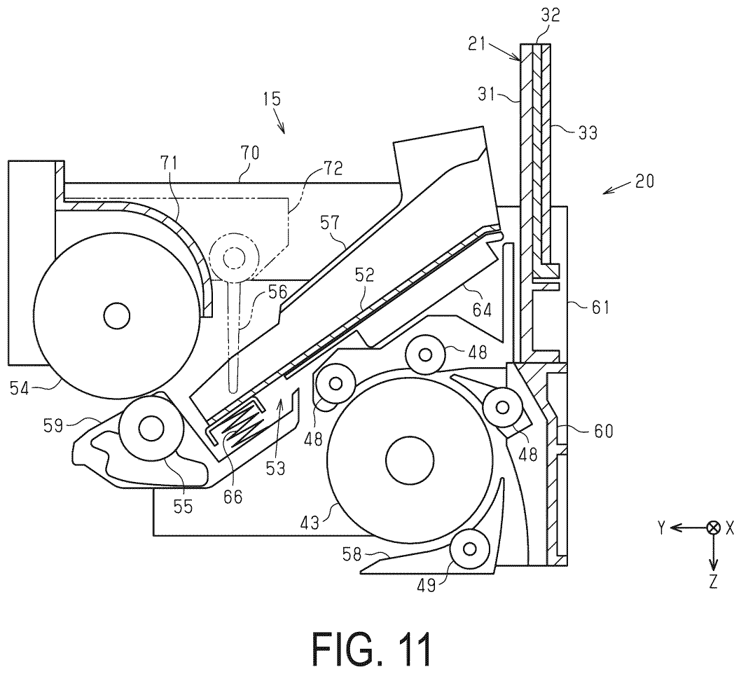

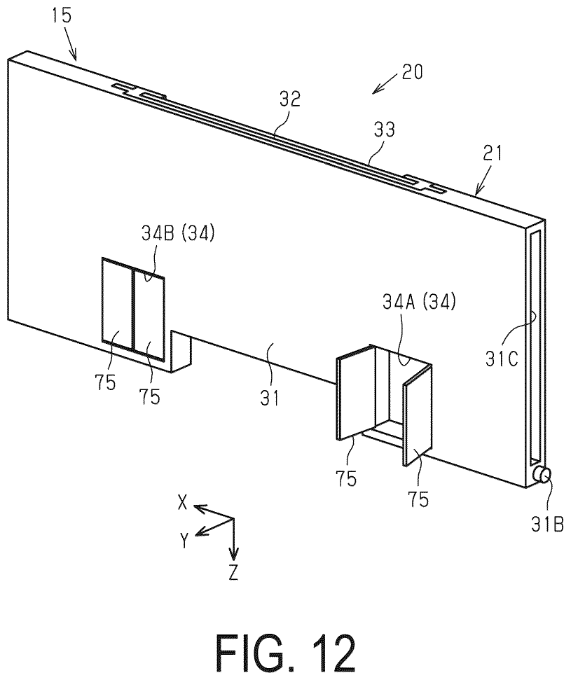

The embodiment described above can be changed to forms as in modifications described below. Furthermore, a further modification can be made by appropriately combining the above embodiment and modifications illustrated below, or a further modification can be made by appropriately combining the modifications illustrated below.
As illustrated in FIG. 11, the reverse path unit 20 may include the supply roller 54 configured to supply the medium M supported by the support tray 21. That is, the supply roller 54 may be configured to be attachable/detachable integrally with the reverse path unit 20. The reverse path unit 20 includes a support member 70 supported by the base 60. The supply roller 54 and a protection member 71 are supported by the support member 70. According to this configuration, it is easy to perform maintenance and replacement of the supply roller 54. The protection member 71 may be omitted. Note that the medium detection unit 56 indicated by the two-dot chain line in FIG. 11 may also be configured to be attachable/detachable integrally with the reverse path unit 20. In this case, the power of the medium detection unit 56 is supplied via a terminal (not illustrated). An inner side surface more behind than the opening 12A of the apparatus body 12 is provided with a terminal coupleable to this terminal. When the reverse path unit 20 is mounted to the apparatus body 12, the two terminals are coupled. The medium detection unit 56 and the support member 72 indicated by the two-dot chain lines in FIG. 11 may be fixed to the apparatus body 12 side. That is, the medium detection unit 56 may be a separate member from the reverse path unit 20. In this case, since a power supply component such as a terminal can be omitted, a simple configuration will suffice.
As illustrated in FIG. 12, the cover 75 configured to cover the opening portion 34 in an openable/closable state may be included. FIG. 12 is a perspective view of the support tray 21 as viewed from the inner surface side. The cover 75 is configured to open toward the inner surface side of the support tray 21 in the storage posture illustrated in FIG. 12. The cover 75 may be biased toward the closed direction. That is, the reverse path unit 20 may include the cover 75 in a state of being biased in the close direction, the cover 75 configured to open/close the opening portion 34 provided at the position corresponding to the operation unit 22 in the support tray 21. The cover 75 is opened by an operation of pushing in a direction from the outside toward the inside of the apparatus body 12. In the recording apparatus 11 of the present embodiment, when the support tray 21 is in the vertical posture, the cover 75 is opened by an operation of pushing in a direction from the front surface 12F toward the rear surface 12R of the apparatus body 12. When the cover 75 is configured to be biased in the close direction, the cover 75 returns from the open position to the closed position by the bias when the user removes the finger from the opening portion 34 after mounting the reverse path unit 20 to the apparatus body 12 again. Since the recording apparatus 11 includes the cover 75 configured to cover the opening portion 34, it is possible to suppress intrusion of dust or the like into the apparatus body 12 through the opening portion 34. At the time of recording, when the medium M is supported on the support tray 21 in the inclined posture, the cover 75 is always disposed at the closed position by the bias in the close direction. Therefore, the medium M placed on the support tray 21 is hardly caught by the cover 75. Note that as the biasing member configured to bias the cover 75 in the close direction, an elastic member such as a spring or rubber may be used.
In the above embodiment, the operation unit 22 has two of the first operation unit 22A and the second operation unit 22B, and the opening portion 34 has two of the first opening portion 34A and the second opening portion 34B, but either one may be one. For example, one opening portion 34 configured to expose both the first operation unit 22A and the second operation unit 22B may be provided. For example, one operation unit 22 may be provided, and two opening portions 34 configured to respectively expose two parts particularly used for operation in one operation unit 22 may be provided.
The number of the operation units 22 is not limited to one or two, and may be three or more. For example, the number of operation units corresponding to the type of size of the user's finger may be provided. For example, two types of operation units 22 corresponding to finger sizes may be provided. The number of the two types of operation units 22 may be two for each type, that is, a total of four. One the operation unit 22 may be common to two types, and a configuration in which a total of three operating units 22 in which another operation unit is provided for each type may be adopted.
The operation unit 22 is not limited to one configured to perform slide operation toward the inside in the width direction X, and may be configured to perform slide operation toward the outside in the width direction X, to perform pivot operation, or to perform push operation.
The opening portion 34 may be provided not limited to the first tray 31 but to the second tray 32. That is, the opening portion 34 may be provided in any of the first tray 31 and the second tray 32 as long as it is a position corresponding to the operation unit 22. When the opening portion 34 is provided in the second tray 32, the opening portion 34 may also penetrate the first tray 31. In this case, the opening portion 34 provided in the second tray 32 may be positioned below the third tray 33 when the support tray 21 is in the storage posture. Furthermore, the opening portion 34 may be provided in the third tray 33. That is, the opening portion 34 penetrating these three trays 31 to 33 may be provided at positions corresponding to the operation unit 22 of the first tray 31, the second tray 32, and the third tray 33 in the storage posture.
One operation unit 22 and one opening portion 34 may be provided.
The opening portion 34 is not limited to a hole provided in the support tray 21, and may be a cutout.
The opening portion 34 may be a cutout that is cut out at a lower end portion of the support tray 21. When the opening portion 34 is such a cutout, the operation unit 22 may protrude more outward (toward the −Y direction) than the inner surface of the support tray 21. In this case, the support tray 21 can be moved from the storage posture to the inclined posture without interfering with the operation unit 22. A part of the operation unit 22 may be positioned in the opening portion 34 in the −Y direction or may protrude from the opening portion 34 in the −Y direction. When the operation unit 22 is at a position away in the depth direction from the opening portion 34, it is difficult to operate. However, such a configuration makes it easy to operate the operation unit 22.
The support tray 21 is not limited to the three-stage type in which the three trays 31 to 33 can be switched between the drawn state and the stored state, and may be a two-stage type or a four-stage type. For example, the support tray 21 may be a two-stage type including two trays of the first tray 31 and the second tray 32. Furthermore, the support tray 21 may include only the first tray 31.
The front cover 14 is not limited to have the configuration of pivoting about the lower end. The front cover 14 may be configured to pivot about a side end. The opening/closing of the front cover 14 is not limited to a pivot type, and may be a slide type. The front cover 14 may be configured to be opened/closed by sliding left/right. Furthermore, as long as the front cover 14 does not interfere with the support tray 21, the front cover 14 may be configured to pivot about the upper end or may be configured to slide up and down.
The open posture of the front cover 14 is not limited to substantially horizontal. The open posture of the front cover 14 may be, for example, +45 degrees or −45 degrees with respect to the horizon.
The front cover 14 may be omitted.
The recording apparatus 11 is not limited to a printer having only a recording function, and may be a multifunction peripheral also having an image reading function (scanner function).
The reverse path unit 20 may be detachably mounted to the rear portion of the apparatus body 12 in place of the front portion.
The recording apparatus 11 is not limited to a line printer or a serial printer, and may be a lateral type printer or a page printer.
The recording apparatus 11 is not limited to the inkjet type, and may be a dot impact type or an electrophotographic type.

### Supplementary Notes

Hereinafter, technical spirits ascertained from the embodiment and the modifications will be described together with the effects.

(A) A medium conveyance apparatus includes an apparatus body, and a reverse path unit including a reverse roller configured to reverse a medium, the reverse path unit being configured to be attachable/detachable to/from the apparatus body, in which the reverse path unit includes a support tray configured to switch between a drawn state where the support tray is drawn out from the reverse path unit and a stored state where the support tray is stored in the reverse path unit, and configured to support a medium to be fed in the drawn state, an operation unit operated to attach/detach the reverse path unit to/from the apparatus body, and an opening portion provided in the support tray and configured to enable operation of the operation unit.

According to this configuration, by providing the support tray with the opening portion through which the operation unit can be accessed, the operation unit can be disposed at an appropriate position regardless of the size in the width direction of the support tray. Therefore, the reverse path unit can be easily attached/detached.

(B) In the medium conveyance apparatus according to (A) described above, the support tray may include a first tray and a second tray configured to switch between a drawn state where the support tray is drawn out from the first tray and a stored state where the support tray is stored in the first tray, and the opening portion may be provided in the first tray, and the support tray may be provided below the second tray in the stored state. According to this configuration, the operation unit can be disposed at an appropriate position regardless of the size in the width direction of the second tray.

(C) In the medium conveyance apparatus according to (A) or (B) described above, the operation unit may include a first operation unit and a second operation unit, and the opening portion may include a first opening portion corresponding to the first operation unit and a second opening portion corresponding to the second operation unit. According to this configuration, it is easy to avoid the two operation units from being separated too much in the width direction of the support tray. The two operation units can be disposed at positions where they are easily operated. Therefore, the reverse path unit can be easily attached/detached.

(D) The medium conveyance apparatus according to any one of (A) to (C) described above may further include a medium accommodation cassette provided below the reverse path unit and configured to be drawn in a direction from a rear surface toward a front surface of the apparatus body, and a front cover provided on the front surface of the apparatus body, in which the support tray may be exposed by bringing the front cover into an open state. According to this configuration, by covering the reverse path unit drawn out from the front surface with the front cover, a decrease in visibility of the operation unit can be reduced as compared with a configuration in which the opening portion is covered with the cover. It is possible to suppress intrusion of dust or the like into the apparatus body.

(E) In the medium conveyance apparatus according to (D) described above, the front cover may assume an open posture in a substantially horizontal state, and the front cover in the open posture may be disposed below the reverse path unit. According to this configuration, even if the reverse path unit is accidentally dropped from the hand when being attached/detached, the front cover supports the reverse path unit, whereby it is possible to prevent failures due to dropping of the reverse path unit from a position higher than the cassette.

(F) The medium conveyance apparatus according to any one of (A) to (E) described above may include a cover configured to cover the opening portion in an openable/closable state. According to this configuration, it is possible to suppress intrusion of dust or the like into the apparatus body from the opening portion.

(G) In the medium conveyance apparatus according to any one of (A) to (F) described above, the reverse path unit may include a supply roller configured to supply the medium supported by the support tray. According to this configuration, the supply roller can also be integrally attached/detached. For example, it is easy to perform maintenance or replacement of the supply roller. For example, it is easy to remove the medium clogged in the supply roller when a jam occurs.

(H) A recording apparatus includes the medium conveyance apparatus according to any one of (A) to (G) described above, and a recording unit configured to perform recording on the medium conveyed by the medium conveyance apparatus. According to this configuration, according to the recording apparatus, the operation unit can be disposed at an appropriate position regardless of the size in the width direction of the support tray. This facilitates attachment/detachment of the reverse path unit.

What is claimed is:

1. A medium conveyance apparatus comprising:
an apparatus body; and
a reverse path unit including a reverse roller configured to reverse a medium, the reverse path unit being configured to be attachable/detachable to/from the apparatus body, wherein
the reverse path unit includes
a support tray configured to switch between a drawn state where the support tray is drawn out from the reverse path unit and a stored state where the support tray is stored in the reverse path unit, and configured to support a medium to be fed in the drawn state,
an operation unit operated to attach/detach the reverse path unit to/from the apparatus body, and
an opening portion provided in the support tray and configured to enable operation of the operation unit.

2. The medium conveyance apparatus according to claim 1, wherein
the support tray includes a first tray and a second tray configured to switch between a drawn state where the support tray is drawn out from the first tray and a stored state where the support tray is stored in the first tray, and
the opening portion is provided in the first tray, and the support tray is provided below the second tray in the stored state.

3. The medium conveyance apparatus according to claim 1, wherein
the operation unit includes a first operation unit and a second operation unit, and
the opening portion includes a first opening portion corresponding to the first operation unit and a second opening portion corresponding to the second operation unit.

4. The medium conveyance apparatus according to claim 1 further comprising:
a medium accommodation cassette provided below the reverse path unit and configured to be drawn in a direction from a rear surface toward a front surface of the apparatus body; and
a front cover provided on the front surface of the apparatus body, wherein
the support tray is exposed by bringing the front cover into an open state.

5. The medium conveyance apparatus according to claim 4, wherein
the front cover assumes an open posture in a substantially horizontal state, and
the front cover in the open posture is disposed below the reverse path unit.

6. The medium conveyance apparatus according to claim 1, further comprising:
a cover configured to cover the opening portion in an openable/closable state.

7. The medium conveyance apparatus according to claim 1, wherein
the reverse path unit includes a supply roller configured to supply the medium supported by the support tray.

8. A recording apparatus comprising:
the medium conveyance apparatus according to claim 1; and
a recording unit configured to perform recording on the medium conveyed by the medium conveyance apparatus.

9. A medium conveyance apparatus comprising:
an apparatus body; and
a reverse path unit including a reverse roller configured to reverse a medium, the reverse path unit being configured to be attachable/detachable to/from the apparatus body, wherein
the reverse path unit includes
a support tray configured to switch between a drawn state where the support tray is drawn out from the reverse path unit and a stored state where the support tray is stored in the reverse path unit, and configured to support a medium to be fed in the drawn state,
a placement unit on which the medium supported by the support tray is placed, and
a hopper unit configured to switch an inclination angle of the placement unit.

10. The medium conveyance apparatus according to claim 9, wherein
the reverse path unit includes a separation roller configured to separate, into one sheet, a medium to be supplied.
